(19) United States
(12) Patent Application Publication
(10) Pub. No.: US 2017/0361422 A1
(43) Pub. Date: Dec. 21, 2017

(54) POLISHING METHOD FOR TURBINE COMPONENTS

(71) Applicant: General Electric Company, Schenectady, NY (US)

(72) Inventors: Terrance Alan Brand, Derry, NH (US); Andrew Lee Trimmer, Niskayuna, NY (US); Kevin Lee Shatley, Niskayuna, NY (US)

(21) Appl. No.: 15/184,605

(22) Filed: Jun. 16, 2016

(51) Int. Cl. B24C 1/08; F04D 29/32

(52) U.S. Cl. CPC B24C 1/08; F04D 29/324; F05D 2220/32; F05D 2300/177; F05D 2230/90

(57) ABSTRACT

A method of polishing a metallic workpiece includes: mounting the workpiece in a hopper; loading the hopper with a polishing media comprising, by weight percent, more than 98% metallic chips, less than 2% liquid, and less than 0.05% abrasive; and oscillating the hopper for a run time, thereby generating a flow of the polishing media over the workpiece, until a predetermined surface finish is achieved on the workpiece.

### BACKGROUND OF THE INVENTION

This invention relates generally to manufacturing methods, and more particularly to apparatus and methods for polishing workpieces.

A gas turbine engine includes a compressor used to pressurize intake air which then flows to a downstream combustor and one or more turbines. A compressor includes one or more rotors each rotor comprising a plurality of airfoil-shaped compressor blades.

Compressor performance may be enhanced by polishing the airfoil and flow surfaces to a low surface finish. Polishing processes for producing low surface finishes are well understood and industrialized.

One problem with prior art polishing processes is that they have a tendency to remove material and therefore change the aerodynamic contours of components such as compressor blades. This can lead to reduced aerodynamic efficiency,

### BRIEF DESCRIPTION OF THE INVENTION

This problem is addressed by a process in which a workpiece is rigidly mounted into a vibratory finishing machine. A polishing media is introduced and the machine is operated with a polishing protocol to achieve a desired improvement in surface finish without negatively affecting the geometry of the workpiece.

According to one aspect of the technology described herein, a method is provided of polishing a metallic workpiece. The method includes: mounting the workpiece in a hopper; loading the hopper with a polishing media comprising, by weight percent, more than 98% metallic chips, less than 2% liquid, and less than 0.05% abrasive; and oscillating the hopper for a run time, thereby generating a flow of the polishing media over the workpiece, until a predetermined surface finish is achieved on the workpiece.

### BRIEF DESCRIPTION OF THE DRAWINGS

The invention may be best understood by reference to the following description taken in conjunction with the accompanying drawing figures in which:

FIG. 1 is a perspective view of a turbomachinery rotor;

FIG. 2 is a schematic, partially-sectioned side elevation view of the turbomachinery rotor disk of FIG. 1 in a polishing machine;

FIG. 3 is a schematic plan view of a metallic chip; and

FIG. 4 is a side elevation view of the metallic chip of FIG. 3.

### DETAILED DESCRIPTION OF THE INVENTION

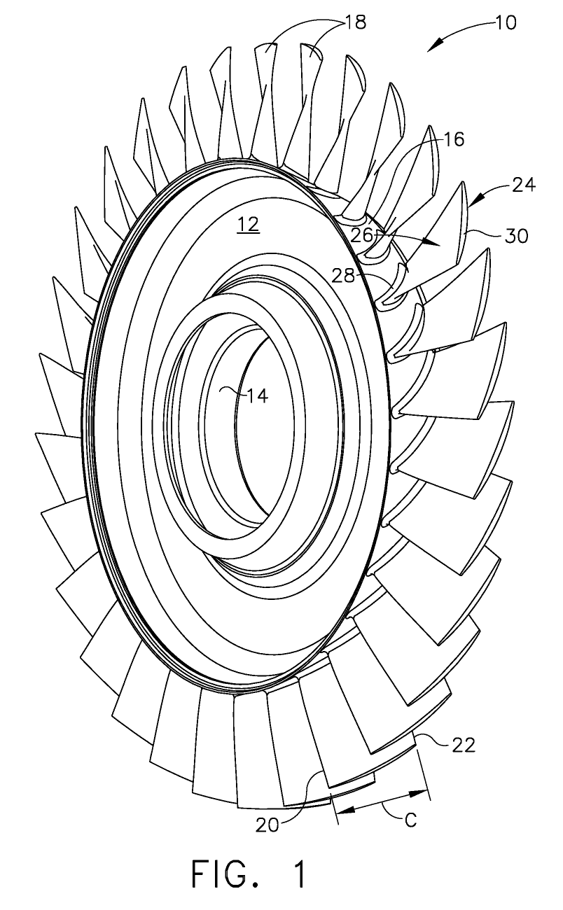

Referring to the drawings wherein identical reference numerals denote the same elements throughout the various views, FIG. 1 illustrates schematically a turbomachinery rotor 10 comprising a disk 12 with a central bore 14 and a rim 16 defining a flow/path surface. An array of airfoils 18 extend radially outward from the rim 16. Each airfoil 18 has a leading edge 20, a trailing edge 22, and a pair of opposed convex and concave side walls 24 and 26 respectively, extending between a root 28 and a tip 30. Each airfoil 18 has a chord dimension “C” measured from the leading edge 20 to the trailing edge 22. In the illustrated example, the airfoils 18 are physically integral to the disk 12. For example, the airfoils 18 may be constructed separately from the disk 12 and then bonded to the disk 12 using a solid state bonding process, or the airfoils 18 and the disk 12 may be machined from a solid billet of material. This type of structure may be referred to by various names such as an “integrally bladed rotor” or “blisk”. This type of turbomachinery rotor may be used in different areas of a gas turbine engine, such as a compressor rotor or a turbine wheel. Furthermore, it will be understood that the rotor 10 is merely an example of many different types of workpieces that may be polished using the method described herein. The rotor 10 may be constructed from various metal alloys, for example a titanium or nickel-based alloy.

As noted above, compressor performance may be enhanced by polishing the airfoils 18 and adjacent flowpath surfaces to a low surface roughness, herein referred to as a “low surface finish”, for example the surface finish may be about 16 Ra or less.

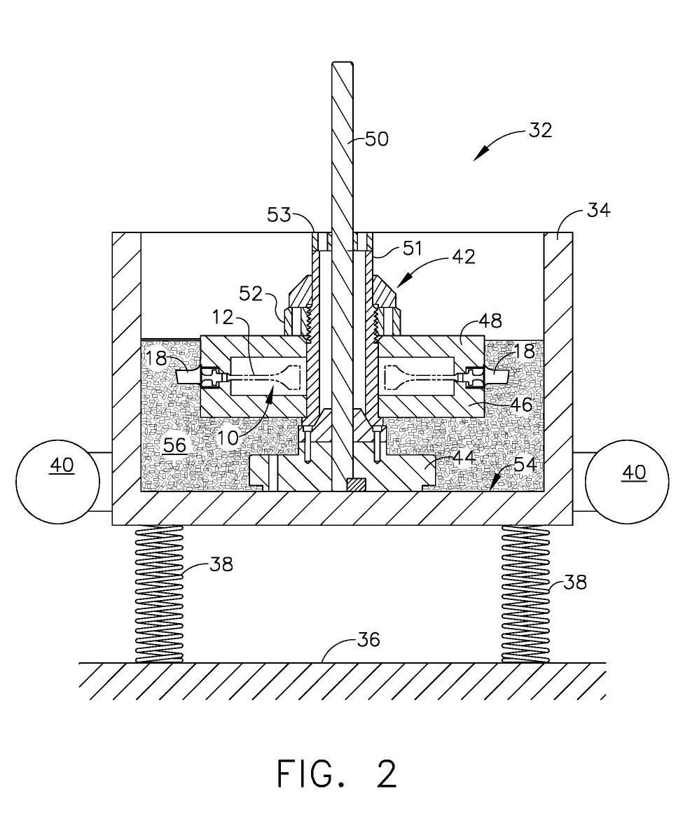

FIG. 2 illustrates an exemplary polishing machine 32 suitable for carrying out the method of the present invention. The polishing machine 32 includes a hopper 34 mounted to a base 36 by an elastic connection, such as the illustrated springs 38. Means are provided for driving the hopper 34 with an oscillatory motion. In the illustrated example, a pair of electric motors 40 are mounted to the hopper 34. Each motor 40 drives (e.g. by rotation) one or more eccentric weights (not shown). Thus operation of the motors 40 causes the hopper 34 to oscillate or shake in motion having both lateral and vertical components. The motors 40 may he controlled in a known manner so that the oscillation at a desired amplitude and frequency.

FIG. 2 also illustrates an exemplary fixture 42 which may be used to mount a turbomachinery rotor 10 to the hopper 34. The fixture 42 incorporates a base 44. lower and upper covers 46 and 48 respectively, a central post assembly 50, a hollow central column 51, a lower clamping element 52, and an upper clamping element 53. In use, base 44 with central post assembly 50 can be mounted to the floor 54 of the hopper 34 and left in place as a semi-permanent installation. The fixture 42 may be assembled outside the hopper 34 by placing the lower cover 46 over the central column 51, then placing the rotor 10 over the lower cover 46, then placing the upper cover 48 over the rotor 10. The lower clamping element 52 is then placed over the upper cover 48 and engaged with the central column 51 to clamp the central column 51, upper and lower covers 46, 48, and rotor 10 securely together as a rigid subassembly. This subassembly may then be placed over the central post assembly 50 and clamped in place with the upper clamping element 53. As an alternative procedure, the hollow central column 51, upper clamping element 53, and lower cover 46 could be left mounted to the base 44 in the hopper 34. The rotor 10, upper cover 48, and lower clamping element could be assembled to the complete fixture 42 inside of the hopper 34. The fixture 42 functions to secure the rotor 10 in the horizontal orientation and to mask off the disk 12, while leaving the airfoils 18 and surrounding portions of the rim 16 exposed.

Once the rotor 10 is secured in the hopper 34, hopper 34 is loaded with a polishing media 56. The polishing media 56 includes an abrasive, metallic chips, and a liquid.

The abrasive takes the form of particles, for example aluminum oxide particles. Abrasive particles are commonly characterized by a metric known as “grit size”, with larger grit numbers corresponding to smaller particle diameters and smaller grit numbers corresponding to larger particle diameters. Commonly, a smaller grit designation is referred to as a “coarse” abrasive, while a larger grit designation is referred to as a “fine” abrasive.

In processing a workpiece one possible practice is to begin a polishing operation using a coarser grit, then to proceed through progressively finer and finer grits until a desired surface finish is achieved. As will be explained further below, the polishing method described herein can be carried out using multiple process steps wherein each step uses an abrasive of a different grit size.

As an alternative to using multiple grit sizes, the abrasive may include abrasive particles held together into larger groups or “clumps” by a binding agent. This combination permits the effective grit size of the abrasive to begin at a coarser value, and as the clumps break down into smaller clumps and/or individual particles, the effective grit size becomes finer. This property permits the abrasive to start out coarse, and become more fine during the polishing process. A nonlimiting example of a suitable binding agent is TRI-AL 860 available from S. P. M. Mould Polishing System srl of Conigliaro, Italy.

A relatively small mass of abrasive is provided in comparison to the size and volume of the workpiece. In order to provide a medium to distribute the abrasive evenly and to provide backing for the abrasive, a medium of dense, soft chips is provided. For example, soft metals such as zinc or copper may be used.

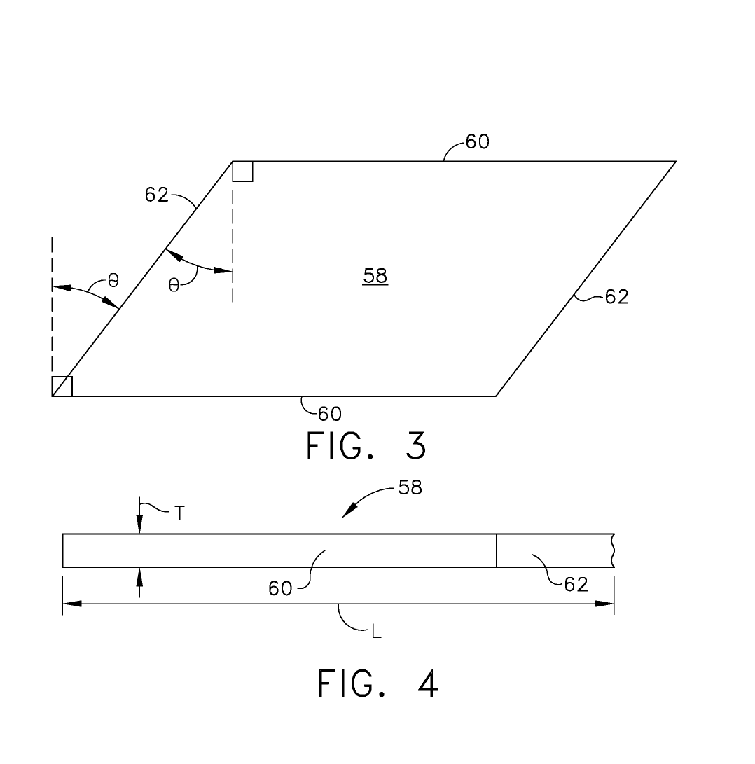

FIGS. 3 and 4 illustrate an example of a metallic chip 58. The illustrated metallic chip 58 consists essentially of copper and has two spaced-apart side edges 60 connected by two end edges 62.

In the illustrated example, the metallic chip 58 has a parallelogram shape in plan view. Stated another way, each end edge 62 intersects the opposed side edges 60 at an angle that is off-perpendicular by an amount θ. In the illustrated example the angle θ is about 30°, but this may vary, for example about 20° to about 40°. It has been observed that the parallelogram shape with non-perpendicular angles is effective to permit free flow of the metallic chips 58 during a polishing process, and to prevent “bridging” or interlocking of the metallic chips 58 with each other that would inhibit free flow.

The dimensions of the metallic chips are sized relative the object to be polished. In other words, larger chips would be used for larger workpieces and smaller chips would be used for smaller workpieces. The example metallic chip 58 has an overall length “L” on the order of 7 mm (0.28 in). The metallic chips 58 are generally thin enough to bend slightly under their own weight. For example their thickness “T” may be on the order of 1 mm (0.040 in).

A suitable liquid such as water is provided as an agent to separate and lubricate the metallic chips 58 so as to permit the metallic chips 58 to flow readily.

A surfactant may be added to the liquid to reduce its surface tension. The specific product used is not critical and any commercially available soap may be used. For example, commercially available detergent is suitable to serve this purpose. Depending on the specific application, special surfactants may be used to meet applicable environmental regulations.

Preferably, the polishing media has the following approximate composition by weight: metallic chips more than 98%, liquid less than 2%, abrasive less than 0.05%. These values may be varied to suit a specific application. An example of one suitable specific composition for the polishing media is as follows, by approximate weight percent: copper chips 98.8, water 1.16, surfactant 0.03, abrasive 0.01.

Once the rotor 10 is mounted and the media 56 is loaded, the process can begin by starting the motors 40 and operating them at a selected speed to achieve a selected frequency of oscillating motion.

The polishing process continues for a run time until the desired surface finish is achieved. For an initial run of a specific component, the run time may be determined by trial and error. Subsequent run times may be then be predetermined based on testing results of the initial run (e.g., measurements from a profilometer, coordinate measuring machine, etc.). Preferably, the run time is about 2.5 hours or less. Testing has shown that periodically reversing the direction of the motors 40 at a predetermined time interval is helpful in producing a consistent and acceptable end result. A nonlimiting example of a suitable time interval for reversing the direction is about 15 minutes.

If an abrasive with a binder is used as described above, the total process time may occur in a single uninterrupted session. Alternatively, if varying grits of abrasive are used, the total process time may be divided into shorter sessions adding up to the predetermined total time. For example, if the total desired process time is one hour, this may comprise 20 minutes of processing each for coarse, medium, and fine grits of abrasive.

The desired surface finish will vary with the specific application. As used herein, the surface roughness is characterized by the arithmetic average roughness value (Ra), expressed in microinches. For example the surface roughness may be less than 16 microinches Ra, preferably less than 8.5 microinches Ra. Using an exemplary rotor 10 comprising a titanium alloy, the process described herein can achieve an average surface roughness of 8.5 Ra with a run time of approximately one hour. This result is achieved while limiting reduction in the chord dimension C, (“chord loss”) to no more than 0.03 mm (0.001 in), while causing no negative impact to the airfoil leading edge shape or rounding of the airfoils tips. As another example, using an exemplary rotor 10 comprising a nickel alloy, the process described herein can achieve an average surface roughness of 6 Ra with a run time of approximately 2.5 hours. This result is also achieved while limiting chord loss to no more than 0.03 mm (0.001 in), and causing no negative impact to the airfoil leading edge shape or rounding of the airfoils tips.

When the polishing process is complete, the hopper 34 is emptied of media 56 and the rotor 10 is removed from the fixture 42. The rotor 10 may be cleaned of excess media 56, for example by a water rinse and drying.

The method described herein has several advantages over the prior art. In particular, testing has shown that the polishing method described herein is effective to obtain a desired surface finish while minimizing loss of material. In particular, the method prevents unacceptable loss in the chord dimension C which has a strong effect on aerodynamic efficiency of the airfoils 18. It is believed that this result is due at least in part to the metallic chips 58 having a size which is large enough to “flow around” thin workpiece features such as the leading edge 20 and trailing edge 22 of the airfoil 18, without significantly damaging or abrading those features.

The foregoing has described an apparatus and method for polishing. All of the features disclosed in this specification (including any accompanying claims, abstract and drawings), and/or all of the steps of any method or process so disclosed, may he combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying potential points of novelty, abstract and drawings), or to any novel one, or any novel combination, of the steps of any method or process so disclosed.

What is claimed is:

1. A method of polishing a metallic workpiece, comprising:
mounting the workpiece in a hopper;
loading the hopper with a polishing media comprising, by weight percent, more than 98% metallic chips, less than 2% liquid, and less than 0.05% abrasive; and
oscillating the hopper for a run time, thereby generating a flow of the polishing media over the workpiece, until a predetermined surface finish is achieved on the workpiece.

2. The method of claim 1 wherein the workpiece is a turbomachinery rotor comprising a disk defining a flowpath surface, and at least one airfoil including opposed pressure and suction sides extending between a leading edge and a trailing edge.

3. The method of claim 2 wherein the turbomachinery rotor is mounted to the hopper with a plane of the disk in a horizontal orientation, such that the airfoils extend in a horizontal direction.

4. The method of claim 2 wherein the turbomachinery rotor is coupled to the hopper by a fixture which masks the disk from the polishing media while exposing the airfoils and optionally the flowpath surface to the polishing media.

5. The method of claim 1, wherein the airfoil has a chord dimension measured from the leading edge to the trailing edge, and a reduction in the chord dimension caused by the polishing process is 0.001 inches or less.

6. The method of claim 1 wherein the abrasive particles comprise aluminum oxide.

7. The method of claim 1 wherein the liquid comprises water.

8. The method of claim 1 wherein the liquid comprises a surfactant.

9. The method of claim 1 wherein the abrasive particles are combined with a binder.

10. The method of claim 1 wherein the metallic chips comprise copper.

11. The method of claim 1 wherein the metallic chips have a parallelogram shape.

12. The method of claim 1 wherein the media consists essentially of, by weight percent, about 0.01% abrasive, about 0.03% surfactant, about 1.16% water, balance metallic chips.

13. The method of claim 1 wherein the workpiece comprises a titanium alloy.

14. The method of claim 13 wherein the run time is about 1.5 hours or less.

15. The method of claim 13, wherein the run time is approximately 1 hour.

16. The method of claim 1, wherein the predetermined surface finish has a final arithmetic average roughness (Ra) equal to or less than approximately 8.5 microinches.

17. The method of claim 1 wherein the workpiece comprises a nickel alloy.

18. The method of claim 17, wherein the run time is about 2.5 hours or less.

19. The method of claim 1 wherein the hopper is oscillated by rotation of at least one eccentric weight coupled to the hopper, the method further comprising reversing a direction of rotation of the at least one eccentric weight at a predetermined time interval.
